(19) United States
(12) Patent Application Publication
(10) Pub. No.: US 2025/0362458 A1
(43) Pub. Date: Nov. 27, 2025

(54) WAVEGUIDE

(71) Applicant: LMS Co., Ltd., Pyeongtaek-si (KR)

(72) Inventors: Hwi KIM, Sejong-si (KR); Shin-Woong PARK, Sejong-si (KR); Seong Yong YOON, Pyeongtaek-si (KR)

(21) Appl. No.: 18/981,811

(22) Filed: Dec. 16, 2024

(30) Foreign Application Priority Data
May 24, 2024 (KR) 10-2024-0067554

(51) Int. Cl. G02B 6/34; G02B 5/18; G02B 27/01

(52) U.S. Cl. CPC G02B 6/34; G02B 5/1809; G02B 5/1842; G02B 27/0101

(57) ABSTRACT

Provided is a waveguide and its applications. The waveguide implements, for example, a VR (Virtual Reality) device, an AR (Augmented Reality) device, a MR (Mixed Reality) device, or a XR (extended Reality) device. Provided is a waveguide that can implement a clear display image with more uniform brightness even when implementing a display image under a relatively large area. The waveguide can implement the display image with more uniform brightness while minimizing loss of brightness. Also provided are applications of the waveguide.

### CROSS-REFERENCE TO RELATED APPLICATION(S)

This application is based on and claims priority under 35 U.S.C. 119 to Korean Patent Application No. 10-2024-0067554, filed on May 24, 2024, in the Korean Intellectual Property Office, the disclosure of which is herein incorporated by reference in its entirety.

### TECHNICAL FIELD

This specification relates to a waveguide and its applications.

### BACKGROUND

A waveguide is a channel that causes repeated reflections of waves between two boundaries. The principle of this waveguide is used, for example, in optical fibers and liquid crystal displays (LCDs).

The waveguide can also be used to implement VR (Virtual Reality), AR (Augmented Reality), MR (Mixed Reality), or XR (extended Reality). For example, Patent Document 1 discloses the use of a waveguide for implementing VR, etc.

In the implementation of virtual reality, light from a light source or display images is transmitted through the waveguide and displayed to the viewer. One of the important things in implementing virtual reality is to ensure that the light or display image displayed to the viewer has a uniform brightness while exhibiting as high a brightness as possible. The Patent Document 1 discloses details for generating uniform brightness by controlling the shape of a diffraction grating of a waveguide.

Most virtual reality implementation technologies known to date, including Patent Document 1, are technologies for implementing virtual reality through eyewear. That is, in conventional technologies, the area where virtual reality is implemented is relatively small.

On the other hand, technologies that require light or display transmission over a relatively wider area, such as AR HUD (Augmented Reality Head-up Display), are being developed. Moreover, the demand for implementing more uniform and brighter light or display over such wider areas is increasing.

(Patent Document 1) Republic of Korea Publication of Patent No. 10-2020-0002791

### SUMMARY

The objective of the present specification is to disclose a waveguide and its applications.

According to an embodiment of the present invention, there is provided that a waveguide comprises that an input diffraction grating pattern, an extended diffraction grating pattern, and an output diffraction grating pattern where each grating pattern is formed for external light to be in-coupled through the input diffraction grating pattern, sequentially to pass through the extended diffraction grating pattern and the output diffraction grating pattern, and then to be out-coupled by the output diffraction grating pattern; either one or both of the extended diffraction grating pattern and the output diffraction grating pattern include(s) a plurality of diffraction grating areas distinguished by a duty cycle; ΔD is negative in Equation 1:

$$Δ D = 100 \times ( {D}_{i} - {D}_{b} ) / {D}_{b} \qquad [ Equation 1 ]$$

where Dᵢ is a duty cycle of any one of a plurality of the diffraction grating areas and D_{b} is a duty cycle of a diffraction grating area through which the light passes before the diffraction grating area having the duty cycle Dᵢ along a path of the in-coupled light; and an absolute value of V is 100% or greater in at least one of a plurality of the diffraction grating areas and AD is 7% or greater or S is 6% or greater in Equation 2:

$$V = 100 \times ( AD - Δ {D}_{A} ) / S \qquad [ Equation 2 ]$$

where AD is an average of absolute values of ΔD in Equation 1, ΔD_{A} is the absolute value of ΔD in Equation 1, and S is a standard deviation of all the absolute values of ΔD for a plurality of the diffraction grating areas in Equation 2.

In an embodiment, a uniformity of the out-coupled light is 75% or greater for the waveguide.

In an embodiment, a uniformity of an out-coupled S polarization is 80% or greater for the waveguide.

In an embodiment, the absolute value of V in Equation 2 is 100% or greater in 1% to 45% of diffraction grating areas among the diffraction grating areas of the diffraction grating pattern including a plurality of the diffraction grating areas for the waveguide.

In an embodiment, the diffraction grating pattern having a plurality of the diffraction grating areas includes four or more of the diffraction grating areas for the waveguide.

In an embodiment, an average value of a duty cycle of the diffraction grating pattern including a plurality of the diffraction grating areas is within a range of 50 nm to 1,000 nm.

In an embodiment, a pitch of the diffraction grating pattern including a plurality of the diffraction grating areas is within a range of 100 nm to 2,000 nm for the waveguide.

In an embodiment, each of the extended diffraction grating pattern and the output diffraction grating pattern includes a plurality of the diffraction grating areas distinguished by the duty cycle; the absolute value of V in Equation 2 is 100% or greater in at least one among a plurality of the diffraction grating areas of the extended diffraction grating pattern; and the absolute value of V in Equation 2 is 100% or greater in at least one among a plurality of the diffraction grating areas of the output diffraction grating pattern for the waveguide.

In an embodiment, the absolute value of V in Equation 2 is 100% or greater in a last diffraction grating area among a plurality of diffraction grating areas of the extended diffraction grating pattern for the waveguide.

In an embodiment, the absolute value of V in Equation 2 is 100% or greater in a last diffraction grating area among a plurality of the diffraction grating areas of the output diffraction grating pattern for the waveguide.

In an embodiment, a smaller angle among angles formed by a first direction of a plurality of the diffraction grating areas of the extended diffraction grating pattern and a second direction of a plurality of the diffraction grating areas of the output diffraction grating pattern is within a range of 70 to 110 degrees for the waveguide.

In an embodiment, an average value Dₑ of a duty cycle of the extended diffraction grating pattern and an average value Dₒ of a duty cycle of the output diffraction grating pattern satisfy Equation 3:

$${D}_{o} > {D}_{e} ; \qquad [ Equation 3 ]$$

and ΔD₂ in Equation 4 is 50% or greater:

$$Δ {D}_{2} = 100 \times ( {D}_{o} - {D}_{e} ) / {D}_{e} \qquad [ Equation 4 ]$$

for the waveguide.

In an embodiment, a pitch Pₑ of the extended diffraction grating pattern and a pitch Pₒ of the output diffraction grating pattern satisfy Equation 5:

$${P}_{o} > {P}_{e} ; \qquad [ Equation 5 ]$$

and ΔP₁ in Equation 6 is 5% or greater:

$$Δ {P}_{1} = 100 \times ( {P}_{o} - {P}_{e} ) / {P}_{e} \qquad [ Equation 6 ]$$

for the waveguide.

In an embodiment, ΔD₃ in Equation 7 is 100% or greater:

$$Δ {D}_{3} = 100 \times ( {D}_{of} - {D}_{el} ) / {D}_{el} \qquad [ Equation 7 ]$$

where Dₑₗ is a duty cycle of the diffraction grating area of the extended diffraction grating pattern through which the light passes last along a path of the in-coupled light to the waveguide and D_{of} is a duty cycle of the diffraction grating area of the output diffraction grating pattern through which the light passes first along the path after passing through the extended diffraction grating pattern in Equation 7 for the waveguide.

In an embodiment, a duty cycle Dᵢₙ of the input diffraction grating pattern and a duty cycle Dₑ of the extended diffraction grating pattern satisfy Equation 8:

$${D}_{i n} > {D}_{e} ; \qquad [ Equation 8 ]$$

and ΔD₄ in Equation 9 is 5% or greater:

$$Δ {D}_{4} = 100 \times ( {D}_{i n} - {D}_{e} ) / {D}_{e} \qquad [ Equation 9 ]$$

for the waveguide.

In an embodiment, a pitch Pᵢₙ of the input diffraction grating pattern and a pitch Pₑ of the extended diffraction grating pattern satisfy Equation 10:

$${P}_{i n} > {P}_{e} ; \qquad [ Equation 10 ]$$

and ΔP₂ in Equation 11 is 5% or greater:

$$Δ {P}_{2} = 100 \times ( {P}_{i n} - {P}_{e} ) / {P}_{e} . \qquad [ Equation 11 ]$$

In an embodiment, ΔD₅ in Equation 12 is 5% or greater:

$$Δ {D}_{5} = 100 \times ( {D}_{if} - {D}_{ef} ) / {D}_{el} \qquad [ Equation 12 ]$$

where D_{if} is a duty cycle of the input diffraction grating pattern and D_{ef} is a duty cycle of the diffraction grating area of the extended diffraction grating pattern through which the light first passes along a path of the in-coupled light to the waveguide in Equation 12 for the waveguide.

In an embodiment, a light emission area is 35 cm² or larger for the waveguide.

According to another embodiment, there is provided that an extended reality device comprises the waveguide.

According to yet another embodiment, there is provided that a head-up display device comprises that the waveguide.

### BRIEF DESCRIPTION OF THE DRAWINGS

FIG. 1 is an example of the arrangement of input, expanded and output diffraction grating patterns.

FIG. 2 is an example of a cross-section of a diffraction grating pattern.

FIG. 3 is an example of the arrangement of input, extended and output diffraction grating patterns.

FIG. 4 is a drawing showing the results of evaluating the uniformity and efficiency of the waveguide of Embodiment 1.

FIG. 5 is a drawing showing the results of evaluating the uniformity and efficiency of the waveguide of Embodiment 1.

FIG. 6 is a drawing showing the results of evaluating the uniformity and efficiency of the waveguide of Comparative Example 1.

FIG. 7 is a drawing showing the results of evaluating the uniformity and efficiency of the waveguide of Comparative Example 1.

### DETAILED DESCRIPTION

Among the properties mentioned in this specification, properties whose results are affected by the measurement temperature are the results measured at room temperature unless otherwise specifically stated.

The term room temperature means the natural temperature that has not been heated or cooled, and means, for example, a temperature within the range of 10° C. to 30° C., or about 23° C. or about 25° C. Additionally, the unit of temperature in this specification is Celsius (° C.) unless otherwise specified.

Among the properties mentioned in this specification, properties whose results are affected by the measurement pressure are the results measured at atmospheric pressure unless specifically stated otherwise.

The term atmospheric pressure is the natural pressure that has not been pressurized or depressurized, and usually means about 740 mmHg to 780 mmHg of the atmospheric pressure level.

Among the properties mentioned in this specification, if humidity affects the results, unless otherwise specified, the properties are properties measured at standard humidity. The standard state humidity means any humidity within the range of 40% to 60%, for example, about 40% or 60% a relative humidity.

In the case where the optical characteristic mentioned in this specification (e.g., refractive index) is a characteristic that varies depending on wavelength, unless specifically stated otherwise, the optical characteristic is a characteristic for light of wavelength 633 nm.

The present specification discloses a waveguide. The waveguide may include at least an input diffraction grating pattern, an extension diffraction grating pattern, and an output diffraction grating pattern.

The term “diffraction grating pattern” refers to a pattern formed on the surface of a waveguide as a plurality of grooves which are formed to generate a spectrum by interference between diffracted light from each groove or to a pattern formed to control the path of light.

The term “input diffraction grating pattern” means a diffraction grating pattern formed so as to receive all or part of light and/or a display image with the waveguide applied and to in-couple the light and/or display image into the interior of the waveguide.

The term “extended diffraction grating pattern” means a diffraction grating pattern formed so as to be able to output all or part of the light and/or display image in-coupled from the input diffraction grating for transmitting as a diffraction grating pattern.

The term “output diffraction grating pattern” means a diffraction grating pattern formed so as to be able to out-couple all or part of the transmitted light and/or the display image from the extended diffraction grating.

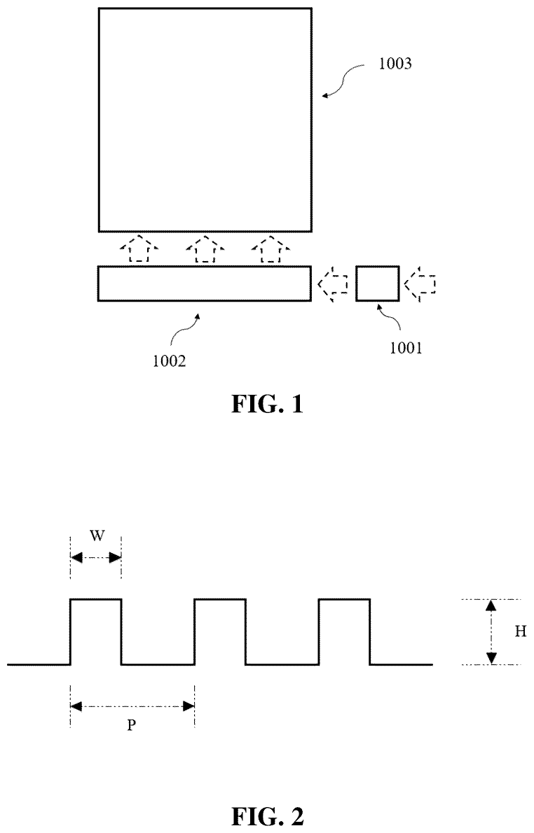

FIG. 1 is an example of the arrangement of the input diffraction grating pattern 1001, the extended diffraction grating pattern 1002 and the output diffraction grating pattern 1003. In FIG. 1, light and/or a display image can be in-coupled and transmitted along the dotted arrow path to be out-coupled to the output diffraction grating pattern 1003.

The waveguide may be an integral waveguide or may be formed by including a plurality of individual waveguide elements. For example, the input, the extended and the output diffraction grating patterns may be simultaneously included in one waveguide, three waveguide elements each formed with the input, the extended and the output diffraction grating patterns may be assembled to form the waveguide, or two waveguide elements formed with diffraction grating patterns among the input, the extended and the output diffraction grating patterns and the remaining one waveguide element may be assembled to form the waveguide.

As exemplified above, the input, the extended and the output grid patterns may be formed such that external light (including a display image) is in-coupled through the input diffraction grating pattern and all or part of in-coupled light sequentially passes through the extended diffraction grating pattern and the output diffraction grating pattern and then, is out-coupled by the output diffraction grating pattern. The input, the extended and the output diffraction grating patterns may each include one diffraction grating area or may include a plurality of diffraction grating area of two or more.

The term “diffraction grating area” refers to a diffraction grating pattern which has substantially the same duty cycle. The definition of duty cycle being “substantially the same” includes cases where small deviations in duty cycle may occur due to unavoidable errors that may occur during the manufacturing process.

The term “duty cycle” means the value obtained by subtracting the width of the grooves from the pitch of the grooves forming the diffraction grating pattern. The pitch and width, and the height of the groove can be defined in the cross section of the diffraction grating pattern in one example.

FIG. 2 is an example of a cross-section of the diffraction grating pattern. FIG. 2 shows an example of diffraction grating pattern in the so-called binary shape, but the diffraction grating pattern applicable to the waveguide is not limited. For example, the diffraction grating pattern may have a so-called blazed shape, a slanted shape, or another shape in addition to the above the binary shape, or may be formed by gathering pattern of different shapes. For example, the shape of the diffraction grating pattern can be a binary shape or a blazed shape.

Typically, diffraction efficiency is the highest in the slanted configuration. However, according to the details disclosed in this specification, even if the shape of the groove is binary or blazed shape, light can be out-coupled with excellent efficiency and uniformity.

As shown in FIG. 2, the pitch P can be a distance from the point where one groove starts in the diffraction grating pattern to the point where another groove adjacent to the groove starts. As shown in FIG. 2, the width W is a dimension of the groove recognized when the diffraction grating pattern is observed from above pattern and this width may be a dimension of the groove confirmed along the same direction as the pitch.

In FIG. 2, the height H of the groove forming the diffraction grating pattern is also shown. For example, at least one of the input, the extended and the output diffraction grating patterns may include a plurality of diffraction grating area. In other words, either one of the extended diffraction grating pattern and the output diffraction grating pattern may include a plurality of the diffraction grating areas or both may include a plurality of the diffraction grating areas.

For example, an extended and/or output diffraction grating pattern including a plurality of the diffraction grating areas may have ΔD of Equation 1 that is negative in one or more of a plurality of the diffraction grating areas.

$$Δ D = 100 \times ( {D}_{i} - {D}_{b} ) / {D}_{b} \qquad [ Equation 1 ]$$

In Equation 1, Dᵢ is a duty cycle of any one grating area among a plurality of the diffraction grating areas. D_{b} is a duty cycle of a grating area that the light passes through before the grating area having the duty cycle Dᵢ along the path of in-coupled light. The meaning of ΔD in Equation 1 is explained with reference to an exemplary drawing.

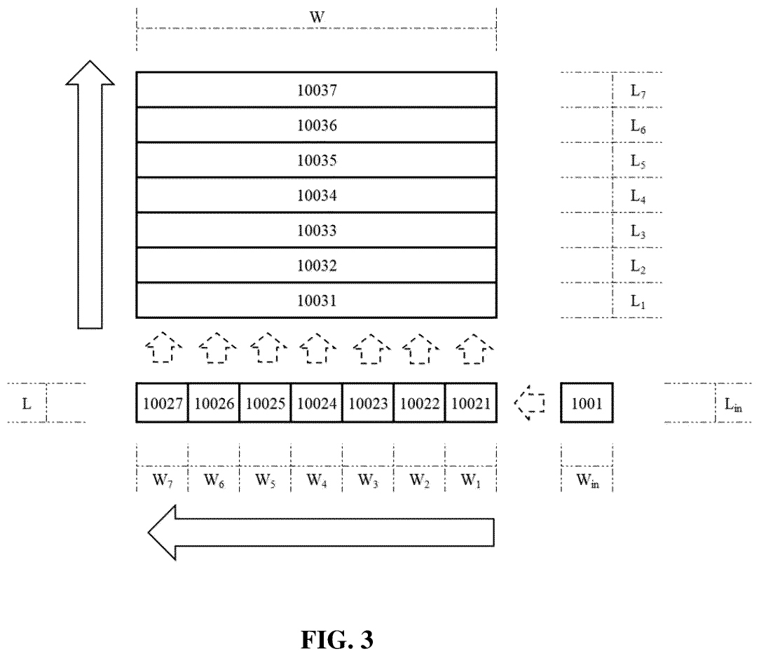

FIG. 3 is an example of a case where the extended diffraction grating pattern 1002 includes seven diffraction patterns grid area 10021 to 10027 and the output diffraction grating pattern 1003 includes seven diffraction patterns grid area 10031 to 10037 in the example of FIG. 1. As described above, only one of the extended and the output diffraction grating patterns 1002, 1003 may include a plurality of the diffraction grating areas and the input diffraction grating pattern 1001 may also include a plurality of the diffraction grating areas if necessary.

As shown in the drawing, the in-coupled light by the input diffraction grating pattern 1001 is transmitted to the extended diffraction grating pattern. The transmitted light proceeds to the solid arrow direction shown at the bottom of FIG. 3 and is transmitted to the output diffraction grating pattern at each diffraction grating area. The transmitted light to the output diffraction grating pattern proceeds along the leftmost solid arrow direction in FIG. 3 to the output diffraction grating pattern and is out-coupled at each diffraction grating area 10031 to 10037.

In Equation 1, Dᵢ is, for example, the duty cycle of any one grating area among a plurality of the diffraction grating areas within one diffraction grating pattern. For example, in the case of FIG. 3, it can be the duty cycle of any one grating area among the diffraction grating areas 10022 to 10027 and/or the duty cycle of any one grating area among the diffraction grating area 10031 to 10037. For example, in FIG. 3, ΔD cannot be defined for the diffraction grating area 10021 and 10031 because there is no diffraction grating area within the diffraction grating pattern that includes the diffraction grating area before passing through the diffraction grating area along the path of light.

D_{b} in Equation 1 is the duty cycle of the grating area that the light passes through before the grating area having the duty cycle Dᵢ along the path of light that has been in-coupled. At this time, the path of light is a direction where light propagates within the diffraction grating pattern which includes a corresponding grating area. For example, referring to FIG. 3, light transmitted from the input diffraction grating pattern 1001 may be partially transmitted to the output diffraction grating pattern at the diffraction grating area 10021, partially transmitted to adjacent diffraction grating area 10022, and partially proceeded in other directions. In Equation 1, the path is the direction from diffraction grating area 10021 to diffraction grating area 10022. Similarly, the light transmitted from an extended diffraction grating pattern may be partially out-coupled at the diffraction grating area 10031, partially transmitted to the adjacent diffraction grating area 10032, and partially propagated in other directions. The path in Equation 1 is the direction from diffraction grating area 10031 to the diffraction grating area 10032.

The fact that ΔD in Equation 1 is negative means that the duty cycle of diffraction grating area decreases along the path where light travels according to the above details. In one example, the lower limit of the number of the diffraction grating area having a negative ΔD relative to the total number of the diffraction grating area among the diffraction grating areas of the diffraction grating pattern including a plurality of the diffraction grating areas for which the ΔD can be defined may be about 30%, 40%, 50%, 60%, 70%, 80%, 90% or 95%, and that of the upper limit may be about 100%. The ratio can be within a range that is equal to or greater than any one of the lower limits described above or with a range which is equal to or greater than any one of the lower limits described above and equal to or less than the upper limit. In one example, the ΔD can be negative among the diffraction grating areas of the diffraction grating pattern including a plurality of the diffraction grating areas where the ΔD can be defined in all diffraction grating area. When calculating the ΔD, the same units are applied for Dᵢ and D_{b}.

The lower limit of the absolute value of the ΔD can be about 0.1%, 0.5%, 1%, 5%, 10%, 15%, 20%, 25% or 30% and the upper limit can be about 150%, 100%, 90%, 80%, 70%, 60%, 50%, 40%, 35%, 30%, 25%, 20%, 15%, 10%, 5%, 3% or 1.5%. The absolute value of the ΔD can be within a range that is equal to or greater than any one of the lower limits described above; within a range that is less than or equal to any one of the upper limits described above; or within a range which is equal to or greater than any one of the lower limits described above and equal to or less than any one of the upper limits.

A diffraction grating pattern including a plurality of the diffraction grating areas can be formed to include the diffraction grating area in which, for example, V of the absolute value of Equation 2 is at a certain level or higher.

$$V = 100 \times ( AD - Δ {D}_{A} ) / S \qquad [ Equation 2 ]$$

In Equation 2, ΔD is average (arithmetic mean) of the absolute values of ΔD in Equation 1. In other words, the AD is the average of ΔD of the absolute values of all diffraction grating areas among the diffraction grating areas of the diffraction grating pattern including a plurality of the diffraction grating areas where ΔD of Equation 1 can be determined.

In Equation 2, ΔD_{A} is the absolute value of ΔD in Equation 1. In other words, the ΔD_{A} is the absolute value of ΔD of Equation 1 obtained from a certain diffraction grating area.

S in Equation 2 is the standard deviation of all ΔD's absolute values for a plurality of the diffraction grating areas. For example, if ΔD obtained from all diffraction grating areas for which ΔD is specified among the diffraction grating areas included in the diffraction grating pattern are D1, D2, D3, and D4 and the average of the absolute value of D1, the absolute value of D2, the absolute value of D3, and the absolute value of D4 is A, then S is a value obtained by [{(absolute value of A−D1)²+(absolute value of A−D2)²+(absolute value of A−D3)²+(absolute value of A−D4)²}/4]^{0.5}.

For example, in a plurality of the diffraction grating areas existing in the diffraction grating pattern, a region where V of the absolute value of Equation 2 is at a certain level or higher can be called as region A. A region where V of Equation 2 is at a certain level or lower can be called as region B.

In the region A, the lower limit of the absolute value of V can be about 100%, 130%, 150%, 170%, 190%, 200%, 250%, 300%, 320% or 340% and the upper limit can be about 1,000%, 900%, 800%, 700%, 600%, 500%, 400%, 350%, 300%, 250% or 200%. In the region A, the absolute value of the V may be within a range that is equal to or greater than any one of the lower limits described above or within a range which is equal to or greater than any one of the lower limits described above and equal to or less than any one of the upper limits.

In the region B, the lower limit of the absolute value of V may be about 1%, 3%, 4%, 5%, 10%, 20%, 30%, 40%, 50%, 60%, 70%, 80% or 90% and the upper limit may be about 100%, 95%, 90%, 80%, 70%, 60%, 50%, 40%, 30%, 20%, 10% or 5%. In the region B, the absolute value of the V may be within a range which is less than or equal to any one of the upper limits among the upper limits described above or within a range which is equal to or greater than any one of the lower limits described above and equal to or less than any one of the upper limits.

The absolute values of V in the region A and B are different from each other. The V can be negative or positive. In one example, V in region A can be negative and V in region B can be positive or negative.

Referring to FIG. 3, V in Equation 2 means that when the duty cycle of the diffraction grating area included in the diffraction grating pattern changes along the path of light (solid arrow direction in FIG. 3), how much of the degree of the change in the diffraction grating area occurs compared to the standard deviation of the degree of change of all diffraction grating area of the diffraction grating pattern. In other words, the larger V is, the more changes in duty cycle for the diffraction grating area representing V compared to the average change of other diffraction grating area.

Referring to FIG. 3, since the input diffraction grating pattern 1001 is the closest to the light source, when the output diffraction grating pattern is considered to correspond to the screen for the display image, it can be expected that the brightness at the lower right of the output diffraction grating pattern will be the brightest and the brightness at the upper left will be the lowest when other conditions are the same. Therefore, to make the brightness of the screen uniform, the amount of light transmission to the output diffraction grating pattern should increase from the diffraction grating area 10021 to the diffraction grating area 10027. In addition, a greater amount of light should be out-coupled from the diffraction grating area 10031 to diffraction grating area 10037.

In addition, it can be expected that it is advantageous for implementing uniform brightness as the amount of light transmission to the output diffraction grating pattern increases from the diffraction grating area 10021 to the diffraction grating area 10027 while the amount of light increasing remains constant. Moreover, it can be expected that it is advantageous for implementing uniform brightness as the amount of out-coupled light increases from diffraction grating area 10031 to diffraction grating area 10037 while the amount of light increasing remains constant.

Typically, the amount of light that is transmitted from a diffraction grating area to another grating area or out-coupled is related to the duty cycle of the diffraction grating area. Therefore, in the example of FIG. 3, it would be theoretically advantageous for implementing uniform brightness that the duty cycle of the area decreases to a uniform ratio as it goes from the diffraction grid area 10021 to the diffraction grating area 10027 and that the duty cycle of the area decreases to a uniform ratio as it goes from the diffraction grating area 10031 to the diffraction grating area 10037.

However, it was found that it is unexpectedly advantageous to efficiently implement the uniform brightness while minimizing the decrease in brightness in the case where there is an area (i.e., the region A) where the change in duty cycle in at least some of a plurality of the diffraction grating areas is larger or smaller than the average change in a plurality of the diffraction grating areas. In particular, when AD of Equation 2 is in the range described below, and/or S of Equation 2 is in the range described below, and the region A is present, the improvement effect of uniformity and/or the improvement effect of efficiency can be further increased. Therefore, in the waveguide disclosed in this specification, for example, the diffraction grating pattern including a plurality of the diffraction grating areas (e.g., the extended and/or the output diffraction grating pattern) can be formed to include the region A in which the absolute value of V of Equation 2 is at a certain level or higher.

In Equation 2, the range of AD, in other words, the average (arithmetic mean) of the absolute values of ΔD in Equation 1 is not particularly limited. For example, the lower limit of the above AD can be about 7, 7.5, 8, 8.5 or 9 and the upper limit can be about 100, 80, 60, 40, 20, 15, 10, 9 or 8. The AD may be within a range that is equal to or greater than any one of the lower limits described above, within a range that is less than or equal to any one of the upper limits described above, or within a range that is equal to or greater than any one of the lower limits described above and equal to or less than any one of the upper limits described above. The unit of the above AD is %. For example, if the output and the extended diffraction grating patterns both include a plurality of diffraction grating areas, the AD in each diffraction grating pattern can be the same or different within the range described above.

S in Equation 2, in other words, the standard deviations of all ΔD's absolute values of a plurality of the diffraction grating areas are not particularly limited. For example, the lower limit of the S can be about 6, 6.5, 7, 7.5, 8, 9, 10 or 11 and the upper limit can be about 100, 80, 60, 40, 20, 15, 10, 9 or 8. The S may be within a range that is equal to or greater than any one of the lower limits described above, within a range that is less than or equal to any one of the upper limits described above; or within a range that is equal to or greater than any one of the lower limits described above and equal to or less than any one of the upper limits described above. The unit of the above S can be %. For example, if the output and the extended diffraction grating patterns both include a plurality of the diffraction grating areas, S in each of the diffraction grating pattern may be the same or different within the range described above.

When the diffraction grating pattern, for example, the output and/or the extended diffraction grating pattern include(s) a plurality of diffraction grating areas, the lower limit of the ratio of the region A for which the V is stipulated among all diffraction grating areas with respect to a plurality of the diffraction grating areas included in the diffraction grating patterns among all diffraction grating areas may be about 1%, 5%, 10% or 15% and the upper limit may be about 45%, 40%, 35%, 30%, 25% or 20%. The ratio may be within a range that is equal to or greater than any one of the lower limits described above, within a range that is less than or equal to any one of the upper limits described above, or within a range that is equal to or greater than any one of the lower limits described above and equal to or less than any one of the upper limits described above. Since there is a possibility that the efficiency and/or uniformity of the out-coupled light may be reduced when the ratio of the region A is excessively high, the ratio of the region A may be adjusted within a range that is not excessively high. Among a plurality of the diffraction grating areas, the area other than the region A may be the region B.

There is no special limit to the number of the diffraction grating areas contained in a diffraction grating pattern if the diffraction grating pattern contains a plurality of diffraction grating areas. For example, the lower limit of the number of diffraction grating areas can be 4, 5, 6 or 7, and the number of the upper limit can be 100, 80, 60, 40, 20, 15 or 10. The number of the diffraction grating areas may be within a range that is equal to or greater than any one of the lower limits described above; within a range that is less than or equal to any one of the upper limits described above; or within a range that is equal to or greater than any one of the lower limits described above and equal to or less than any one of the upper limits described above.

The duty cycle of each of the input, the extended and the output diffraction grating patterns can be within an appropriate range depending on the purpose. For example, the lower limit of the duty cycle can be about 50 nm, 100 nm, 150 nm, 200 nm, 250 nm, 300 nm or 350 nm and the upper limit can be about 1,000 nm, 900 nm, 800 nm, 700 nm, 600 nm, 500 nm, 400 nm, 350 nm, 300 nm, 250 nm, 200 nm, 180 nm or 160 nm. The duty cycle may be within a range that is greater than or equal to any one of the lower limits described above; within a range that is less than or equal to any one of the upper limits described above; or within a range that is equal to or greater than any one of the lower limits described above and equal to or less than any one of the upper limits described above.

If the input, the extended and/or the output diffraction grating pattern includes a plurality of the diffraction grating areas, the duty cycle is the average value of the duty cycles of a plurality of the diffraction grating areas. The duty cycles of each of the input, the extended and the output diffraction grating patterns may be equal to or different from each other within the range described above. For example, if the duty cycles of the input, extended and the output diffraction grating patterns are different from each other, the duty cycle of the output diffraction grating pattern may have the largest value, and the duty cycle of the extended diffraction grating pattern may have the smallest value.

The pitch of each of the input, the extended and the output diffraction grating patterns can be within an appropriate range depending on the purpose. For example, the lower limit of the pitch can be about 50 nm, 100 nm, 150 nm, 200 nm, 250 nm, 300 nm, 350 nm, 400 nm, 450 nm or 500 nm and the upper limit can be about 2,000 nm, 1,500 nm, 1,000 nm, 900 nm, 800 nm, 700 nm, 600 nm, 500 nm or 400 nm. The pitch may be within a range equal to or greater than any one of the lower limits described above; within a range that is less than or equal to any one of the upper limits described above; or within a range that is equal to or greater than any one of the lower limits described above and equal to or less than any one of the upper limits described above.

If the input, the extended and/or the output diffraction grating pattern include(s) a plurality of the diffraction grating areas, the pitch is the average value of the pitch of a plurality of the diffraction grating areas. In one example, if the diffraction grating pattern includes a plurality of the diffraction grating areas, the pitch in each of the diffraction grating areas may be substantially the same.

The pitch of each of the input, the extended and the output diffraction grating patterns may be the same or different within the range described above. For example, if the pitches of the input, the extended and the output diffraction grating patterns are different from each other, the pitch of the extended diffraction grating pattern may have the smallest value. In this case, the pitches of the input and the extended diffraction grating pattern may be the same or different.

Each of the height of the input, the extended and the output diffraction grating patterns (e.g., H in FIG. 2) may be within an appropriate range depending on the purpose. For example, the lower limit of the height can be about 10 nm, 50 nm, 100 nm, 150 nm or 200 nm and the upper limit can be about 1,000 nm, 900 nm, 800 nm, 700 nm, 600 nm, 500 nm, 400 nm, 300 nm or 250 nm. The height may be within a range that is equal to or greater than any one of the lower limits described above; within a range that is less than or equal to any one of the upper limits described above; or within a range that is equal to or greater than any one of the lower limits described above and equal to or less than any one of the upper limits described above.

The height of the input, the extended and/or the output diffraction grating pattern is the average value of the height when each pattern includes different parts of the heights. In one example, the height of the groove within the diffraction grating pattern may or may not be substantially constant.

In one example, at least the extended and the output diffraction grating patterns among the input, the extended and the output diffraction grating patterns may include a plurality of the diffraction grating areas distinguished by duty cycles. In this case, the extended diffraction grating pattern may also contains one or more region A and the output diffraction grating pattern may also contains one or more region A.

In this case, the lower limit of the ratio of region A where V is stipulated in each of the output and the extended diffraction grating pattern among all diffraction grating areas may be about 1%, 5%, 10% or 15% and that of the upper limit may be about 45%, 40%, 35%, 30%, 25% or 20%. The ratio may be within a range that is equal to or greater than any one of the lower limits described above; within a range less than or equal to any one of the upper limits described above; or within a range that is equal to or greater than any one of the lower limits described above and equal to or less than any one of the upper limits described above.

When the extended diffraction grating pattern includes a plurality of the diffraction grating areas, at least the last diffraction grating area may be the region A. At this time, the last diffraction grating area means a diffraction grating area where the light passes through the last one along the path of the light among the diffraction grating areas existing in the extended diffraction grating pattern, and for example, it means the diffraction grating areas 10027 of FIG. 3.

When the output diffraction grating pattern includes a plurality of the diffraction grating areas, at least the last diffraction grating area may be the region A. At this time, the last diffraction grating area means a diffraction grating area where the light passes through the last one along the path of the light among the diffraction grating area existing in the output diffraction grating pattern, and for example, it means the diffraction grating areas 10037 of FIG. 3.

In the waveguide, a first direction formed by a plurality of the diffraction grating areas of the extended diffraction grating pattern (for example, the solid arrow direction at the very bottom of the drawing in FIG. 3) and a second direction formed by a plurality of diffraction grating areas of the output diffraction grating pattern (for example, the solid arrow direction at the very left of the drawing in FIG. 3) can be adjusted. For example, the lower limit of the smaller angle among the angles formed by the first and second directions may be about 70 degrees, 75 degrees, 80 degrees, 85 degrees or 90 degrees, and the upper limit may be about 110 degrees, 105 degrees, 100 degrees, 95 degrees or 90 degrees. The angle may be within a range that is equal to or greater than any one of the lower limits described above; within a range that is less than or equal to any one of the upper limits described above; or within a range that is equal to or greater than any one of the lower limits described above and equal to or less than any one of the upper limits described above. The angle can be approximately 90 degrees in one example.

In the waveguide, the average Dₑ of the duty cycle for the extended diffraction grating pattern and the average Dₒ of the duty cycle for the output diffraction grating pattern can satisfy a predetermined relationship. For example, the Dₒ may be relatively greater than the Dₑ. In this case, ΔD2 of Equation 4 can be within a certain range.

$$Δ {D}_{2} = 100 \times ( {D}_{o} - {D}_{e} ) / {D}_{e} \qquad [ Equation 4 ]$$

In Equation 4, Dₑ is the average value of the duty cycle of the extended diffraction grating pattern, and Dₒ is the average value of the duty cycle of the output diffraction grating pattern. The lower limit of ΔD₂ in Equation 4 can be about 50%, 70%, 90%, 110%, 130%, 140%, or 145%, and the upper limit can be about 1,000%, 900%, 800%, 700%, 600%, 500%, 400%, 300%, 200%, 180%, 160%, or 150%. The ΔD₂ may be within a range that is equal to or greater than any one of the lower limits described above; within a range that is less than or equal to any one of the upper limits described above; or within a range that is equal to or greater than any one of the lower limits described above and equal to or less than any one of the upper limits described above.

In the waveguide, the pitch Pe of the extended diffraction grating pattern (the average value of the pitch when the pitches of a plurality of the diffraction grating areas are different from each other) and the pitch Po of the output diffraction grating pattern (the average value of the pitch when the pitches of a plurality of the diffraction grating areas are different from each other) can satisfy a predetermined relationship. For example, the Po may be relatively greater than the Pe. In this case, ΔP₁ of Equation 6 can be within a certain range.

$$Δ {P}_{1} = 100 \times ( Po - Pe ) / Pe \qquad [ Equation 5 ]$$

In Equation 6, Pe is the pitch of the extended diffraction grating pattern (the average value of the pitch when the pitches of a plurality of the diffraction grating areas are different from each other). Po is the pitch of the output diffraction grating pattern (the average value of the pitch when the pitches of a plurality of the diffraction grating areas are different from each other).

The lower limit of ΔP₁ in Equation 6 can be about 5%, 10%, 15%, 20%, 25%, 30%, 35%, or 40% and the upper limit can be about 500%, 400%, 300%, 200%, 100%, 90%, 80%, 70%, 60%, 50%, or 45%. The ΔP₁ may be within a range that is equal to or greater than any one of the lower limits described above; within a range that is less than or equal to any one of the upper limits described above; or within a range that is equal to or greater than any one of the lower limits described above and equal to or less than any one of the upper limits described above.

To achieve the purpose, the design of the above-mentioned waveguide can be further adjusted. For example, the waveguide can be designed so that ΔD₃ of Equation 7 is within a predetermined range.

$$Δ {D}_{3} = 100 \times ( {D}_{of} - {D}_{el} ) / {D}_{el} . \qquad [ Equation 7 ]$$

In Equation 7, Dₑₗ is the duty cycle of a diffraction grating area of the extended diffraction grating pattern where the light passes through the last one along the path of in-coupled light to the waveguide (e.g., diffraction grating area 10027 in the case of FIG. 3). D_{of} is the duty cycle of a diffraction grating area of the output diffraction grating pattern where the light passes through the first one after passing through the extended diffraction grating pattern along the path.

The lower limit of ΔD₃ in Equation 7 can be about 100%, 150%, 200%, 250%, or 300%, and the upper limit can be about 1,500%, 1,000%, 900%, 800%, 700%, 600%, 500%, 400%, or 350%. The ΔD₃ may be within a range that is equal to or greater than any one of the lower limits described above; within a range that is less than or equal to any one of the upper limits described above; or within a range that is equal to or greater than any one of the lower limits described above and equal to or less than any one of the upper limits described above.

In the waveguide, Dᵢₙ, the duty cycle of the input diffraction grating pattern (the average of the duty cycles of a plurality of the diffraction grating areas in the case of including a plurality of the diffraction grating areas). Dₑ, the duty cycle of the extended diffraction grating pattern (the average of the duty cycles of a plurality of the diffraction grating areas in the case of including a plurality of the diffraction grating areas) can satisfy a predetermined relationship. For example, the Dᵢₙ may be relatively greater than the Dₑ. In this case, ΔD₄ of Equation 9 can be within a certain range.

$$Δ {D}_{4} = 100 \times ( {D}_{in} - {D}_{e} ) / {D}_{e} . \qquad [ Equation 9 ]$$

In Equation 9, Dᵢₙ is the duty cycle of the input diffraction grating pattern (the average of the duty cycles of a plurality of diffraction grating areas in the case where a plurality of the diffraction grating area is included). Dₑ is the duty cycle of the extended diffraction grating pattern (the average of the duty cycles of a plurality of diffraction grating areas in the case where a plurality of the diffraction grating area is included).

The lower limit of ΔD₄ in Equation 9 can be about 5%, 10%, 15%, 20%, 25%, 30%, 35%, or 40% and the upper limit can be about 500%, 400%, 300%, 200%, 100%, 90%, 80%, 70%, 60%, 50%, or 45%. The ΔD₄ may be within a range that is equal to or greater than any one of the lower limits described above; within a range that is less than or equal to any one of the upper limits described above; or within a range that is equal to or greater than any one of the lower limits described above and equal to or less than any one of the upper limits described above.

Pᵢₙ, the pitch of the input diffraction grating pattern (the average of the pitches of a plurality of the diffraction grating areas in the case of including a plurality of the diffraction grating areas). Pₑ, the pitch of the extended diffraction grating pattern (the average of the pitches of a plurality of the diffraction grating areas in the case of including a plurality of the diffraction grating areas) can satisfy a predetermined relationship. For example, the Pᵢₙ may have a relatively larger value than Pₑ. In this case, ΔP₂ of Equation 11 can be within a certain range.

$$Δ {P}_{2} = 100 \times ( {P}_{in} - {P}_{e} ) / {P}_{e} . \qquad [ Equation 11 ]$$

In Equation 11, Pᵢₙ is the pitch of the input diffraction grating pattern (the average of the pitches of a plurality of the diffraction grating areas in the case where a plurality of the diffraction grating area is included). Pₑ is the pitch of the extended diffraction grating pattern (the average of the pitches of a plurality of the diffraction grating areas in the case where a plurality of the diffraction grating area is included).

The lower limit of ΔP₂ in Equation 11 can be about 5%, 10%, 15%, 20%, 25%, 30%, 35%, or 40%, and the upper limit can be about 500%, 400%, 300%, 200%, 100%, 90%, 80%, 70%, 60%, 50%, or 45%. The ΔP₂ may be within a range that is equal to or greater than any one of the lower limits of described above; within a range less than or equal to any one of the upper limits described above; or within a range that is equal to or greater than any one of the lower limits described above and equal to or less than any one of the upper limits described above.

The waveguide can also be designed so that ΔD₅ of Equation 12 is within a predetermined range.

$$Δ {D}_{5} = 100 \times ( {D}_{if} - {D}_{ef} ) / {D}_{el} \qquad [ Equation 12 ]$$

In Equation 12, D_{if} is the duty cycle of the input diffraction grating pattern (the average of the duty cycles in the case of including a plurality of the diffraction grating areas). D_{ef} is the duty cycle of the diffraction grating area of the extended diffraction grating pattern (diffraction grating area 10021 in the case of FIG. 3) where the light first passes through along the path of in-coupled light.

The lower limit of ΔD₅ in Equation 12 can be about 1%, 5%, 10%, 15%, or 20% and the upper limit can be about 500%, 400%, 300%, 200%, 100%, 90%, 80%, 70%, 60%, 50%, 40%, 30%, or 25%. The ΔD₅ may be within a range that is equal to or greater than any one of the lower limits described above; within a range that is less than or equal to any one of the upper limits described above; or within a range that is equal to or greater than any one of the lower limits described above and equal to or less than any one of the upper limits described above.

The waveguide can be manufactured by a known method using a known waveguide forming material. In other words, the waveguide disclosed in this specification may follow the known method and its material and manufacturing method when a diffraction grating pattern is formed according to the design described above.

For example, the waveguide may have a refractive index which represents a material of a typical waveguide. For example, the lower limit of the refractive index of the above-described waveguide may be about 1.40, 1.45, 1.50, 1.55 or 1.60 and the upper limit may be about 1.80, 1.75, 1.70, 1.65 or 1.60. The refractive index is a value referenced to a wavelength of 633 nm. The refractive index may be within a range that is equal to or greater than any one of the lower limits described above; within a range that is less than or equal to any one of the upper limits described above; or within a range that is equal to or greater than any one of the lower limits described above and equal to or less than any one of the upper limits described above.

The waveguide is usually manufactured by the so-called imprinting method. In other words, it is manufactured by replicating a desired shape of a diffraction grating pattern utilizing a predetermined mold or by etching method which cuts away a material to have a desired diffraction grating pattern. The waveguide disclosed in this specification can be manufactured by the known methods as mentioned above.

In case where the size of the diffraction grating pattern or the diffraction grating pattern includes a plurality of the diffraction grating areas, the size of the diffraction grating area can be adjusted to an appropriate level as necessary. At this time, the size is a dimension measured along the path of light within the waveguide, for example, in FIG. 3, the size of the input diffraction grating pattern 1001 is indicated as Wᵢₙ, the diffraction grating areas of the extended diffraction grating pattern 10021 to 10027 of the size are indicated as W₁ to W₇, and the diffraction grating areas of the output diffraction grating pattern 10031 to 10037 of the size are indicated as L₁ to L₇.

The lower limit of the size can be about 1 mm, 3 mm, 5 mm, 7 mm, 9 mm or 11 mm and the upper limit can be about 100 mm, 90 mm, 80 mm, 70 mm, 60 mm, 50 mm, 40 mm, 30 mm, 20 mm, 15 mm or 10 mm. The size may be within a range that is equal to or greater than any one of the lower limits described above; within a range that is less than or equal to any one of the upper limits described above; or within a range that is equal to or greater than any one of the lower limits described above and equal to or less than any one of the upper limits described above.

The size of each diffraction grating pattern or diffraction grating area may be identical or different within the above range. In one example, if one diffraction grating pattern contains a plurality of the diffraction grating areas, the sizes of a plurality of the diffraction grating areas within one diffraction grating pattern can be substantially identical. At this time, the fact that “the sizes are substantially identical” means that the standard deviation of the sizes is below a certain level. For example, the standard deviation of the upper limit of the sizes, which is substantially identical, can be about 5 mm, 4 mm, 3 mm, 2 mm, 1 mm or 0.5 mm and the lower limit can be about 0 mm. The standard deviation may be within a range that is less than or equal to any one of the upper limits among the upper limits described above or within a range that is equal to or greater than any one of the lower limits described above and equal to or less than any one of the upper limits described above.

The size of the diffraction grating pattern or diffraction grating area and the ratio of the size in the direction perpendicular can also be adjusted to an appropriate level as needed. At this time, the ratio is a ratio of the dimension measured along the direction perpendicular to the path of the light with respect to the dimension measured along the path of the light within the waveguide. For example, referring to FIG. 3, the ratio of the diffraction grating area 10037 is W/L₇, the ratio of the diffraction grating area 10027 is L/W₇, and the ratio of the input diffraction grating pattern 1001 is Lᵢₙ/Wᵢₙ.

The lower limit of the ratio can be about 0.1, 0.5, 1, 3, 5, 7, 9 or 11 and the upper limit can be about 100, 90, 80, 70, 60, 50, 40, 30, 20, 15, 10, 8, 6, 4, 2 or 1. The ratio may be within a range that is equal to or greater than any one of the lower limits described above; within a range that is less than or equal to any one of the upper limits described above; or within a range that is equal to or greater than any one of the lower limits described above and equal to or less than any one of the upper limits described above. The ratios in each diffraction grating pattern or diffraction grating area may be the same or different from each other within the range.

Through the design described above, the waveguide can out-couple light to have uniform brightness. For example, the lower limit of the uniformity of all polarizations out-coupled from the above-described waveguide can be about 75%, 77%, 79% or 80% and the upper limit can be about 100%, 95%, 90% or 85%. The ratio may be within a range that is equal to or greater than any one of the lower limits described above or within a range that is equal to or greater than any one of the lower limits described above and equal to or less than any one of the upper limits described above. The uniformity was confirmed in the manner described in “Test Example 1” of embodiments of this specification.

The above-mentioned waveguide can perform out-coupling of light under the efficiency of excellence and the excellent uniformity. For example, the lower limit of the efficiency of all polarizations out-coupled from the waveguide can be about 1%, 2%, 3%, 4%, 5% or 5.5% and the upper limit can be about 50%, 45%, 40%, 35%, 30%, 25%, 20%, 15%, 10%, 9%, 8%, 7% or 6%. The efficiency may be within a range equal to or greater than any one of the lower limits of described above or within a range that is equal to or greater than any one of the lower limits described above and equal to or less than any one of the upper limits described above. The efficiency was confirmed by the method described in “Test Example 1” of embodiments of this specification.

From the perspective of the uniformity and the efficiency of S polarization of the out-coupled light, the performance of the waveguide can be further improved. For example, the lower limit of the uniformity of all S polarizations out-coupled in the waveguide can be about 80%, 81%, 82%, 83%, 84% or 85% and that of the upper limit can be about 100%, 95%, 90% or 85%. The ratio may be within a range that is equal to or greater than any one of the lower limits described above or within a range that is equal to or greater than any one of the lower limits described above and equal to or less than any one of the upper limits described above. The uniformity was confirmed in the manner described in “Test Example 1” of embodiments of this specification.

For example, the lower limit of the efficiency of all S polarizations outcoupled from the waveguide can be about 1%, 2%, 3%, 4%, 5%, 6%, 7%, 8% or 8.5% and that of the upper limit can be about 50%, 45%, 40%, 35%, 30%, 25%, 20%, 15%, 10% or 9%. The efficiency may be within a range equal to or greater than any one of the lower limits described above or within a range that is equal to or greater than any one of the lower limits described above and equal to or less than any one of the upper limits described above. The efficiency was confirmed by the method described in “Test Example 1” of embodiments of this specification.

According to the design of the waveguide, even if the area of the waveguide, in other words, an out-coupling area or a light emission area is large, the above-mentioned excellent uniformity and/or efficiency can be secured. For example, the lower limit of the light emission area of the waveguide can be about 30 cm², 35 cm², 40 cm² or 45 cm² and the upper limit can be about 500 cm², 450 cm², 400 cm², 350 cm², 300 cm², 250 cm², 200 cm², 150 cm², 100 cm², 90 cm², 80 cm², 70 cm², 60 cm² or 50 cm². The light emission area may be within a range that is equal to or greater than any one of the lower limits described above or within a range that is equal to or greater than any one of the lower limits described above and equal to or less than any one of the upper limits described above.

The present specification also discloses uses of the above-described waveguide. For example, the present specification discloses an extended reality device which includes the above-described waveguide. Examples of the extended reality device include a VR (Virtual Reality) device, an AR (Augmented Reality) device, a MR (Mixed Reality) device, or a XR (extended Reality) device.

There is no particular limitation on the method of configuring the extended reality device by applying the above-described waveguide, and device can be implemented in a known manner as long as the waveguide disclosed in this specification is applied.

For example, the present specification discloses a Head-Up Display (HUD) device which includes the above-described waveguide. The HUD device may be the so-called an AR (Augmented Reality) Head-Up Display device.

There is no particular limitation on the method of configuring the HUD device by applying the above-described waveguide. The device can be implemented in a known manner as long as the waveguide disclosed in this specification is applied.

The above-described waveguide, etc. will be described in detail through Embodiments and Comparative Examples, but the scope of the above-described waveguide is not limited to the Embodiments presented below.

### Embodiment 1

The waveguide was implemented using a common material used in the implementation of a waveguide (acrylic material with a refractive index of approximately 1.60 for light with a wavelength of 633 nm). The waveguide is implemented such that it includes an input diffraction grating pattern 1001 and an extended diffraction grating pattern and output diffraction grating pattern as exemplified in FIG. 3, and the extended diffraction grating pattern includes seven diffraction grating areas 10021 to 10027, and the output diffraction grating pattern includes seven diffraction grating areas 10031 to 10037.

The waveguide was manufactured so that L₁ to L₇ in FIG. 3 were each about 7 mm, W was each about 100 mm, W₁ to W₇ and Wᵢₙ were each about 12 mm, and L and Lᵢₙ were each about 10 mm. Each diffraction grating area 10021 to 10027 and 10031 to 10037 and the groove of the input diffraction grating pattern 1001 were made in binary form as in FIG. 2, and at this time, the pitch P, width W, duty cycle of a binary form and height H were made in the form as in Table 1 below. In Table 1, DC is the duty cycle.

Table 1 also shows ΔD of Equation 1 and V of Equation 2. In Table 1, the units of width, pitch, height and duty cycle are nm, and the units of ΔD and V are %.

TABLE 1

| | | Width (W) | Peach (P) | DC | Height (H) | ΔD | V |
|---|---|---|---|---|---|---|---|
| Input Diffraction | | 220 | 510 | 220 | 200 | | |
| Grating Pattern | | | | | | | |
| Extended | 10021 | 184 | 360 | 184 | 200 | | |
| Diffraction | 10022 | 182 | 360 | 182 | 200 | −1 | 98 |
| Grating | 10023 | 160 | 360 | 160 | 200 | −12 | −52 |
| Pattern | 10024 | 154 | 360 | 154 | 200 | −4 | 59 |
| | 10025 | 150 | 360 | 150 | 200 | −3 | 75 |
| | 10026 | 140 | 360 | 140 | 200 | −7 | 20 |
| | 10027 | 108 | 360 | 108 | 200 | −23 | −197 |
| Output | 10031 | 438 | 510 | 438 | 200 | | |
| Diffraction | 10032 | 428 | 510 | 428 | 200 | −2 | 79 |
| Grating | 10033 | 418 | 510 | 418 | 200 | −2 | 78 |
| Pattern | 10034 | 402 | 510 | 402 | 200 | −4 | 58 |
| | 10035 | 382 | 510 | 382 | 200 | −5 | 43 |
| | 10036 | 352 | 510 | 352 | 200 | −8 | 4 |
| | 10037 | 232 | 510 | 232 | 200 | −34 | −347 |

### Comparative Example 1

The waveguide was manufactured in the same manner as Embodiment 1 except that the pitch P, width W, duty cycle and the grooves H of the binary form of the diffraction grating area 10021 to 10027 and 10031 to 10037 and the input diffraction grating pattern 1001 were adjusted as shown in Table 2 below.

In Table 2, DC is the duty cycle. Table 2 also shows ΔD in Equation 1 and V in Equation 2. In Table 2, the units of width, pitch, height, and duty cycle are nm, and the units of ΔD and V are %.

TABLE 2

| | | Width (W) | Peach (P) | DC | Height (H) | ΔD | V |
|---|---|---|---|---|---|---|---|
| Input Diffraction | | 220 | 510 | 220 | 200 | | |
| Grating Pattern | | | | | | | |
| Extended | 10021 | 184 | 360 | 184 | 200 | | |
| Diffraction | 10022 | 182 | 360 | 182 | 200 | −1 | 124 |
| Grating | 10023 | 160 | 360 | 160 | 200 | −12 | −181 |
| Pattern | 10024 | 154 | 360 | 154 | 200 | −4 | 50 |
| | 10025 | 150 | 360 | 150 | 200 | −3 | 82 |
| | 10026 | 140 | 360 | 140 | 200 | −7 | −31 |
| | 10027 | 130 | 360 | 130 | 200 | −7 | −44 |
| Output | 10031 | 438 | 510 | 438 | 200 | | |
| Diffraction | 10032 | 428 | 510 | 431 | 200 | −2 | 109 |
| Grating | 10033 | 418 | 510 | 421 | 200 | −2 | 89 |
| Pattern | 10034 | 402 | 510 | 405 | 200 | −4 | 49 |
| | 10035 | 382 | 510 | 388 | 200 | −4 | 38 |
| | 10036 | 352 | 510 | 354 | 200 | −9 | −89 |
| | 10037 | 300 | 510 | 300 | 200 | −15 | −268 |

### Test Example 1

The efficiency and uniformity of the waveguide were evaluated in the following manner. The light was irradiated using a light source to an input diffraction grating pattern 1001 of a waveguide in Embodiment 1 and Comparative Example 1. The light was irradiated with unpolarized light of approximately 532 nm wavelength at an intensity of 300 mW/cm².

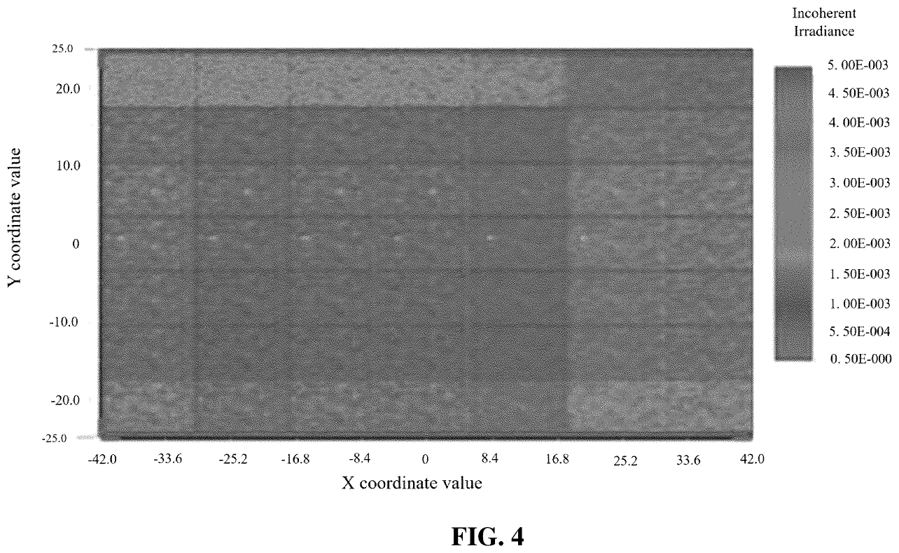

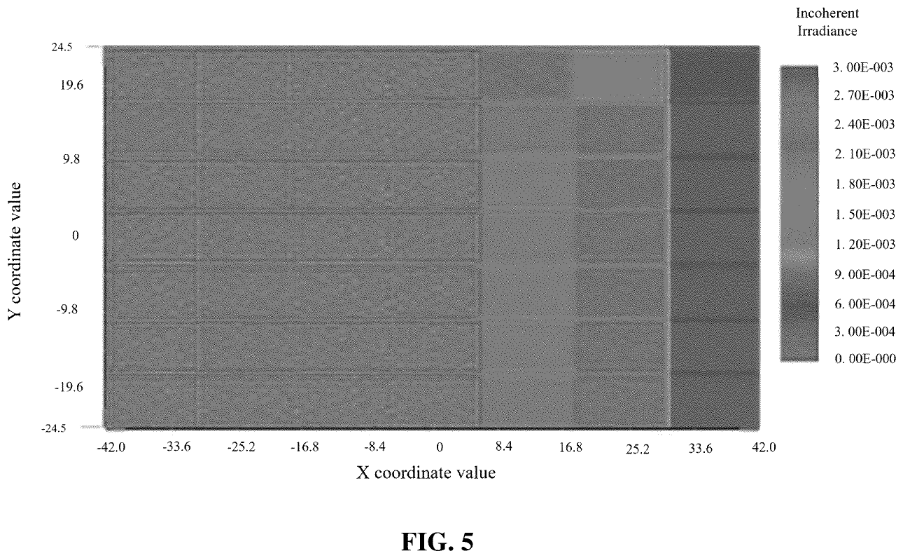

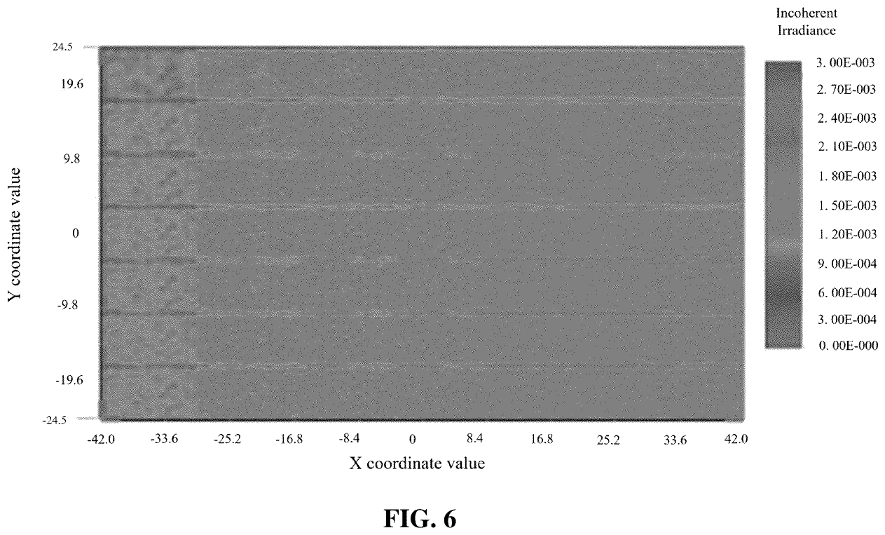

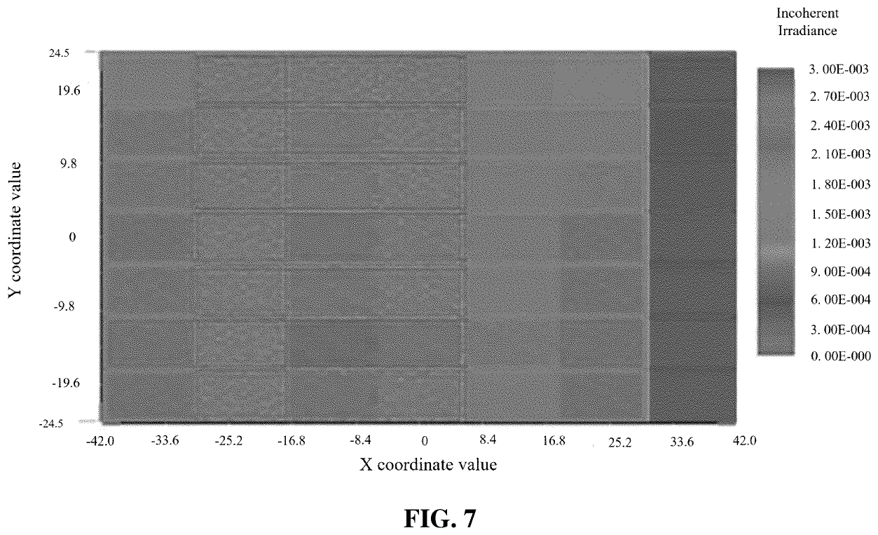

Subsequently, light quantity and brightness of the light out-coupled from the output diffraction grating pattern of the waveguide were evaluated, respectively. In the above, the light quantity was measured light quantity of the entire out coupling area and the brightness was evaluated in each area after dividing the out coupling area formed by a waveguide into 49 areas of the same area as shown in FIGS. 4 to 7. The light quantity and brightness were evaluated using a Photodiode Power Sensor (S121C) from Thorlabs.

Then, the efficiency was calculated according to Equation A and the uniformity was calculated according to Equation B.

$$Efficiency ( \% ) 1 = 100 \times {L}_{out} / {L}_{in} \qquad [ Equation A ]$$

In Equation A, Lᵢₙ is the light quantity of the light irradiated from the light source and Lₒᵤₜ is the light quantity of the light out-coupled from the out coupling area. The units of Lᵢₙ and Lₒᵤₜ are the same.

When calculating the efficiency for all polarizations in Table 3, the light quantity of all light irradiated from the light source was substituted for Lᵢₙ and the light quantity of all light outcoupled from the out coupling area was substituted for Lₒᵤₜ. When calculating the efficiency for S polarization in Table 3, the light quantity of S polarization among the light irradiated from the light source was substituted for Lᵢₙ and the light quantity of S-polarized light among the light out-coupled from the out coupling area was substituted for Lₒᵤₜ.

$$Uniformity ( \% ) = 100 \times {B}_{min} / {B}_{max} \qquad [ Equation B ]$$

In Equation B, Bₘᵢₙ is the lowest brightness among the brightness measured in each of the 49 areas which are the same area, Bₘₐₓ is the highest brightness among the brightness measured in each of the 49 areas which are the same area. The units of Bₘₐₓ and Bₘᵢₙ are the same.

When calculating uniformity for all polarizations in Table 3, the brightness for all polarizations was substituted for Bₘᵢₙ and Bₘₐₓ, respectively, and when calculating uniformity for S polarization, the brightness for S polarization was substituted for Bₘᵢₙ and Bₘₐₓ, respectively.

TABLE 3

| | | Efficiency (%) | Uniformity (%) |
|---|---|---|---|
| Embodiment 1 | All polarization | 5.8 | 80 |
| | S polarization | 8.6 | 85 |
| Comparative | All polarization | 5.4 | 74 |
| Example 1 | S polarization | 8.5 | 74 |

From the results in Table 3, it can be confirmed that the waveguide of Embodiment 1 exhibits higher efficiency and uniformity than Comparative Example 1, and from the perspective of S polarization, it can be confirmed that the characteristics can be further improved.

What is claimed is:

1. A waveguide comprising:
an input diffraction grating pattern, an extended diffraction grating pattern, and an output diffraction grating pattern,
wherein each grating pattern is formed for an external light to be in-coupled through the input diffraction grating pattern, sequentially to pass through the extended diffraction grating pattern and the output diffraction grating pattern, and then to be out-coupled by the output diffraction grating pattern;
wherein either one or both of the extended diffraction grating pattern and the output diffraction grating pattern include(s) a plurality of diffraction grating areas distinguished by a duty cycle;
wherein ΔD is negative in Equation 1:
$$Δ D = 100 \times ( {D}_{i} - {D}_{b} ) / {D}_{b} , \qquad [ Equation 1 ]$$
wherein Dᵢ is a duty cycle of any one of a plurality of the diffraction grating areas and D_{b} is a duty cycle of a diffraction grating area through which the light passes before the diffraction grating area having the duty cycle Dᵢ along a path of the in-coupled light; and
wherein an absolute value of V is 100% or greater in at least one of a plurality of the diffraction grating areas and AD is 7% or greater or S is 6% or greater in Equation 2:
$$V = 100 \times ( AD - Δ {D}_{A} ) / S , \qquad [ Equation 2 ]$$
wherein AD is an average of absolute values of ΔD in Equation 1, ΔD_{A} is the absolute value of ΔD in Equation 1, and S is a standard deviation of all the absolute values of ΔD for a plurality of the diffraction grating areas in Equation 2.

2. The waveguide of claim 1, wherein a uniformity of the out-coupled light is 75% or greater.

3. The waveguide of claim 1, wherein a uniformity of an out-coupled S polarization is 80% or greater.

4. The waveguide of claim 1, the absolute value of V in Equation 2 is 100% or greater in 1% to 45% of diffraction grating areas among the diffraction grating areas of the diffraction grating pattern including a plurality of the diffraction grating areas.

5. The waveguide of claim 1, wherein the diffraction grating pattern having a plurality of the diffraction grating areas includes four or more of the diffraction grating areas.

6. The waveguide of claim 1, wherein an average value of a duty cycle of the diffraction grating pattern including a plurality of the diffraction grating areas is within a range of 50 nm to 1,000 nm.

7. The waveguide of claim 1, wherein a pitch of the diffraction grating pattern including a plurality of the diffraction grating areas is within a range of 100 nm to 2,000 nm.

8. The waveguide of claim 1, wherein each of the extended diffraction grating pattern and the output diffraction grating pattern includes a plurality of the diffraction grating areas distinguished by the duty cycle; the absolute value of V in Equation 2 is 100% or greater in at least one among a plurality of the diffraction grating areas of the extended diffraction grating pattern; and the absolute value of V in Equation 2 is 100% or greater in at least one among a plurality of the diffraction grating areas of the output diffraction grating pattern.

9. The waveguide of claim 8, wherein the absolute value of V in Equation 2 is 100% or greater in a last diffraction grating area among a plurality of diffraction grating areas of the extended diffraction grating pattern.

10. The waveguide of claim 8, wherein the absolute value of V in Equation 2 is 100% or greater in a last diffraction grating area among a plurality of the diffraction grating areas of the output diffraction grating pattern.

11. The waveguide of claim 8, wherein a smaller angle among angles formed by a first direction of a plurality of the diffraction grating areas of the extended diffraction grating pattern and a second direction of a plurality of the diffraction grating areas of the output diffraction grating pattern is within a range of 70 to 110 degrees.

12. The waveguide of claim 8, wherein an average value Dₑ of a duty cycle of the extended diffraction grating pattern and an average value Dₒ of a duty cycle of the output diffraction grating pattern satisfy Equation 3:
$${D}_{0} > {D}_{e} ; \qquad [ Equation 3 ]$$
and
ΔD₂ in Equation 4 is 50% or greater:
$${D}_{2} = 100 \times ( {D}_{o} - {D}_{e} ) / {D}_{e} . \qquad [ Equation 4 ]$$

13. The waveguide of claim 8, wherein a pitch Pₑ of the extended diffraction grating pattern and a pitch Pₒ of the output diffraction grating pattern satisfy Equation 5:
$${P}_{0} > {P}_{e} ; \qquad [ Equation 5 ]$$
and
ΔP₁ in Equation 6 is 5% or greater:
$$Δ {P}_{1} = 100 \times ( {P}_{o} - {P}_{e} ) / {P}_{e} . \qquad [ Equation 6 ]$$

14. The waveguide of claim 8, wherein ΔD₃ in Equation 7 is 100% or greater:
$$Δ {D}_{3} = 100 \times ( {D}_{of} - {D}_{el} ) / {D}_{el} , \qquad [ Equation 7 ]$$
wherein Dₑₗ is a duty cycle of the diffraction grating area of the extended diffraction grating pattern through which the light passes last along a path of the in-coupled light to the waveguide and D_{of} is a duty cycle of the diffraction grating area of the output diffraction grating pattern through which the light passes first along the path after passing through the extended diffraction grating pattern in Equation 7.

15. The waveguide of claim 8, wherein a duty cycle Dᵢₙ of the input diffraction grating pattern and a duty cycle Dₑ of the extended diffraction grating pattern satisfy Equation 8:
$${D}_{in} > {D}_{e} ; \qquad [ Equation 8 ]$$
and
ΔD₄ in Equation 9 is 5% or greater:
$$Δ {D}_{4} = 100 \times ( {D}_{in} - {D}_{e} ) / {D}_{e} . \qquad [ Equation 9 ]$$

16. The waveguide of claim 1, wherein a pitch Pᵢₙ of the input diffraction grating pattern and a pitch Pₑ of the extended diffraction grating pattern satisfy Equation 10:
$${P}_{i n} > {P}_{e} ; \qquad [ Equation 10 ]$$
and
ΔP₂ in Equation 11 is 5% or greater:
$$Δ {P}_{2} = 100 \times ( {P}_{i n} - {P}_{e} ) / {P}_{e} . \qquad [ Equation 11 ]$$

17. The waveguide of claim 1, wherein ΔD₅ in Equation 12 is 5% or greater:
$$Δ {D}_{5} = 100 \times ( {D}_{if} - {D}_{ef} ) / {D}_{el} , \qquad [ Equation 12 ]$$
wherein D_{if} is a duty cycle of the input diffraction grating pattern and D_{ef} is a duty cycle of the diffraction grating area of the extended diffraction grating pattern through which the light first passes along a path of the in-coupled light to the waveguide in Equation 12.

18. The waveguide of claim 1, wherein a light emission area is 35 cm₂ or larger.

19. An extended reality device comprising a waveguide of claim 1.

20. A head-up display device comprising a waveguide of claim 1.
